(19) United States
(12) Patent Application Publication
(10) Pub. No.: US 2016/0343370 A1
(43) Pub. Date: Nov. 24, 2016

(54) SPEECH FEEDBACK SYSTEM

(71) Applicant: Dictionary.com, Oakland, CA (US)

(72) Inventor: Richard J. Carey, Half Moon Bay, CA (US)

(73) Assignee: Dictionary.com, Oakland, CA (US)

(21) Appl. No.: 14/716,050

(22) Filed: May 19, 2015

(51) Int. Cl. G10L 15/22; G10L 15/08

(52) U.S. Cl. CPC G10L 15/22; G10L 15/08; G10L 2015/088; G10L 2015/225

(57) ABSTRACT

A user stores feedback events in the form of one-word and/or multiple-word terms that the user wishes to reduce or eliminate from their language. A speech detection device continuously detects speech of a person speaking and converts the speech to computer data representing the speech. A speech analysis system analyzes the computer data to determine whether the computer data has a feedback event. A sensory output device such as a speaker of vibrating device provides a sensory output that is perceivable by the person to indicate occurrence of the feedback event to the person.

### BACKGROUND OF THE INVENTION

1). Field of the Invention

This invention relates to a speech feedback system and to a method of providing speech feedback to a person speaking

2). Discussion of Related Art

Voice recognition systems have been used for some time to transcribe spoken language to text. A microphone is used to detect speech of a person speaking and for converting the speech to computer data representing the speech. Words and phrases are identified by spaces between the words. The words in the computer data are then compared with reference data to find matches and extract corresponding text from any matched data.

The resulting text may be used for various purposes. Authors may for example generate text-based documents from their speech. Some authors may be able to create documents much faster from their speech than by typing the documents.

FIG. 10 illustrates the functioning of an interactive command system according to the prior art. Sound waves due to speech are detected by a microphone. A signal generated by the microphone creates computer data that is stored and analyzed. An analysis system usually detects the beginning and the end of a keyword. When the keyword is detected, the microphone may still be switched on, but the signal generated by the microphone is not used for storing any computer data and/or no computer data is analyzed to find any additional keywords. Instead, a response action is executed. By way of example, the keyword may indicate that the user wishes to access their email and the response action may be to open an email application. Following the response action, a prompt is provided, which again starts the storing and analysis of the computer data. The user's speech is thus analyzed to determine a further response keyword. When the response keyword is detected, data analysis is again terminated and a response action is carried out followed by another prompt.

People are aware that they often use words, or terms comprising multiple words, that they wish to stop using. A person giving a speech may for example wish to eliminate certain words or terms. Traditional voice recognition systems do not provide any feedback to a person wishing to reduce or eliminate certain words from their speech. An interactive command system that functions in the manner shown in FIG. 10 has a number of drawbacks, for example that the analysis is not continuous in the sense that there are pauses to allow for a response action while no analysis of the speech is carried out. These systems have not been designed with the concept in mind of providing sensory feedback to a person wishing to eliminate certain words or terms from their speech.

### SUMMARY OF THE INVENTION

The invention provides a speech feedback system. A speech detection device detects speech of a person speaking and converting the speech to computer data representing the speech. A speech analysis system is configured to receive the computer data and initiate analysis of the computer data to determine whether the computer data has a feedback event. No feedback event is detected for a first time section of the computer data and a first feedback event is detected in a second time section after the first time section. A sensory output device activator is connected to the speech analysis system so that, when the speech analysis system detects the first feedback event, the speech analysis system provides a first feedback output to the sensory output device activator in response to the detection of the first feedback output. A sensory output device is connected to the sensory output device activator so as to be activated in response to the first feedback output. The sensory output device provides a sensory output that is perceivable by the person to indicate occurrence of the first feedback event to the person, while continuously detecting the speech and continuously analyzing the speech. In various embodiments the sensory output device my for example include a display, an audio device and/or a tactile device. The feedback may alert the user by way of audio feedback, visual feedback, vibrational feedback and/or by storing feedback in a history log for later retrieval.

The speech detection device may be a microphone that detects the speech by sensing sound waves from the speech and converts the sound waves to the computer data.

The system can work in two different modes: 1) real-time continuous recognition, and 2) offline analysis (record audio and analyze after the fact). During real-time continuous recognition, the analysis is may continuously carried out while the speech is continuously being detected.

A first feedback output may be provided while continuously detecting the speech.

The sensory output device may be activated while continuously detecting the speech and continuously analyzing the speech.

The speech feedback system may further include that no feedback event is detected for a third time section after the second time section and a second feedback event is detected in a fourth time section after the third time section, when the second feedback event is detected, providing a second feedback output in response to the detection of the second feedback output, and the sensory output device is activated in response to the second feedback output, the sensory output device providing a sensory output that is perceivable by the person to indicate occurrence of the second feedback event to the person, while continuously detecting the speech and continuously analyzing the speech.

The analysis is preferably continuously carried out while the speech is continuously being detected in the third section of time.

The feedback event may be a term that includes one or more words spoken over a period of time and the term is detected at the end of the period of time.

The speech feedback system may further include a data store and a term input module receiving a plurality of terms though an input device operated by the user and storing the terms in a data store. A “black list” of terms may be created by entering text, from a file, by voice recording or from previously recorded audio.

The speech feedback system may further include a speech detection initiator that instructs the speech detection device to initiate detection of the speech and a speech analysis initiator that instructs the speech analysis system to initiate analysis of the computer data.

The speech feedback system may further include an instructional module separate from the speech analysis system, the term input module, speech detection initiator and speech analysis initiator forming part of the instructional module.

The speech feedback system may further include a data receiver receiving the computer data and transmitting the computer data from a mobile device over a network to a remote service, wherein the sensory feedback device activator receives a result at the mobile device from the remote service indicating that the first feedback event is detected by the remote service and wherein the sensory feedback device activator receives a result at the mobile device from the remote service indicating that the second feedback event is detected by the remote service.

The speech feedback system may further include a term input module receiving a plurality of terms though an input device operated by the user, and transmitting the terms to the remote service, wherein the feedback event is a term that includes one or more words spoken over a period of time and the term is detected at the end of the period of time by the remote service.

The invention also provides a method of providing speech feedback to a person speaking Speech of a person speaking may be detected with a speech detection device and be converted to computer data representing the speech. Analysis of the computer data may be initiated to determine whether the computer data has a feedback event. No feedback event may be detected for a first time section of the computer data and a first feedback event may be detected in a second time section after the first time section. When the first feedback event is detected, a first feedback output may be provided in response to the detection of the first feedback output. A sensory output device may be activated in response to the first feedback output. The sensory output device may provide a sensory output that is perceivable by the person to indicate occurrence of the first feedback event to the person, while continuously detecting the speech and continuously analyzing the speech.

The speech detection device may be a microphone that detects the speech by sensing sound waves from the speech and converts the sound waves to the computer data.

The analysis is preferably continuously carried out while the speech is continuously being detected.

The first feedback output is preferably provided while continuously detecting the speech.

The sensory output device is preferably activated while continuously detecting the speech and continuously analyzing the speech.

The method may further include that no feedback event is detected for a third time section after the second time section and a second feedback event is detected in a fourth time section after the third time section, further including when the second feedback event is detected, providing a second feedback output in response to the detection of the second feedback output and activating the sensory output device in response to the second feedback output, the sensory output device providing a sensory output that is perceivable by the person to indicate occurrence of the second feedback event to the person, while continuously detecting the speech and continuously analyzing the speech.

The analysis that is preferably continuously carried out while the speech is continuously being detected in the third section of time.

The feedback event may be a term that includes one or more words spoken over a period of time and the term is detected at the end of the period of time.

A plurality of terms may be received though an input device operated by the user and storing the terms in a data store.

The computer data may be transmitted from a mobile device over a network to a remote service. A result may be received at the mobile device from the remote service indicating that the first feedback event is detected by the remote. A result may be received at the mobile device from the remote service indicating that the second feedback event is detected by the remote service.

A plurality of terms may be received though an input device operated by the user and transmitting the terms to the remote service, wherein the feedback event is a term that includes one or more words spoken over a period of time and the term is detected at the end of the period of time by the remote service.

The invention further provides a computer-readable medium having stored thereon a set of instructions which, when executed by a processor carries out a method of providing speech feedback to a person speaking.

### BRIEF DESCRIPTION OF THE DRAWINGS

The invention is further described by way of examples with reference to the accompanying drawing, wherein:

FIG. 1 is block diagram of a speech feedback system according to one embodiment of the invention;

FIGS. 2 and 3 are views of interfaces of a mobile phone;

FIG. 4 is a flow chart illustrating the functioning and use of the speech feedback system of FIG. 1;

FIG. 5 is a time chart illustrating the functioning of the speech feedback system of FIG. 1;

FIG. 6 is a block diagram of a mobile device illustrating SmartPhone features thereof;

FIG. 7 is a block diagram of a speech feedback system according to an alternate embodiment of the invention;

FIG. 8 is a block diagram of speech feedback system according to a further embodiment of the invention;

FIG. 9 is a block diagram of a machine in the form of a computer system forming part of the remote service of FIG. 8; and

FIG. 10 is a time chart illustrating an interactive speech-based command system according to the prior art.

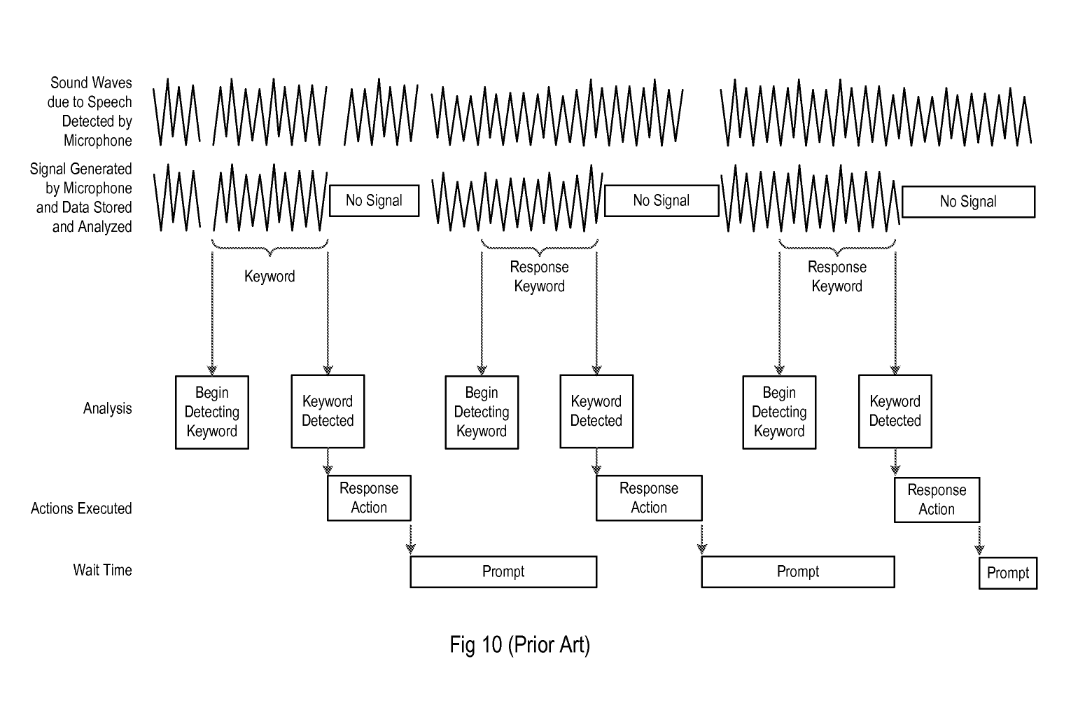

### DETAILED DESCRIPTION OF THE INVENTION

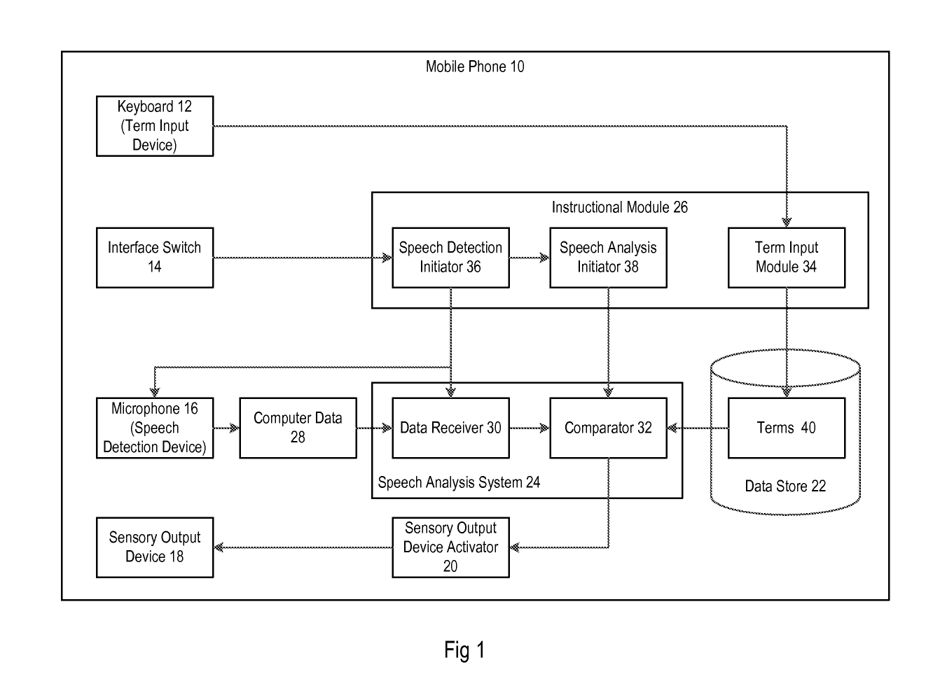

FIG. 1 of the accompanying drawings illustrates a speech feedback system, according to an embodiment of the invention. The speech feedback system includes a consumer mobile device in the form of a mobile phone 10 having a keyboard 12 serving as a term input device, an interface switch 14, a microphone 16 serving as a speech detection device, a sensory output device 18 such as a speaker or a vibration device, a sensory output detection activator 20, a data store 22, a speech analysis system 24, and an instructional module 26.

The microphone 16 detects speech by sensing sound waves from the speech and converts the sound waves to computer data 28. The computer data 28 is continuously stored in memory while the microphone 16 senses the sound waves.

The speech analysis system 24 includes a data receiver 30 and a comparator 32. The data receiver 30 is connected to the memory and receives the computer data 28 from the memory.

The instructional module 26 includes a term input module 34, a speech detection initiator 36 and a speech analysis initiator 38. The term input module 34 is connected to the keyboard 12 to receive terms that are entered by a user using the keyboard 12. The term input module 34 then stores the terms as terms 40 in the data store 22.

The speech detection initiator 36 and speech analysis initiator 38 are connected to the interface switch 14 and are activated when the interface switch 14 is switched from an “off” state to “on” state. The switch may alternatively be timer controlled such that the user can set a period of time after which it switches off.

The speech detection initiator 36 is connected to the data receiver 30. The speech detection initiator 36, when activated, instructs the data receiver 30 to initiate reception of the computer data 28.

The speech analysis initiator 38 is connected to the comparator 32. The speech analysis initiator 38, when activated, instructs the comparator 32 to initiate analysis of the computer data 28 received by the data receiver 30.

The comparator 32 is connected to the data receiver 30 so as to receive the computer data 28 from the data receiver 30. The comparator 32 receives the computer data 28 as a live stream while the microphone 16 detects the sound waves of the speech. The comparator 32 is also connected to the data store 22 and has access to the terms 40. In one embodiment, the comparator 32 converts the computer data 28 to text and compares the text to the terms 40 to determine whether the text has any one of the terms 40. A term found within the computer data 28 matching any one of the terms 40 is referred to as a “feedback event.”

The sensory output device activator 20 is connected to the comparator 32. When the comparator 32 detects a feedback event, the comparator 32 provides a feedback output to the sensory output device activator 20. The sensory output device activator 20 provides an output to the sensory output device 18. The user of the mobile phone, while speaking in a manner to be sensed by the microphone 16 is provided with a sensory output by the sensory output device 18 to indicate the occurrence of the feedback event. The sensory output device may for example be a speaker providing an auditory feedback or a vibration device providing a vibration that can be sensed by the person.

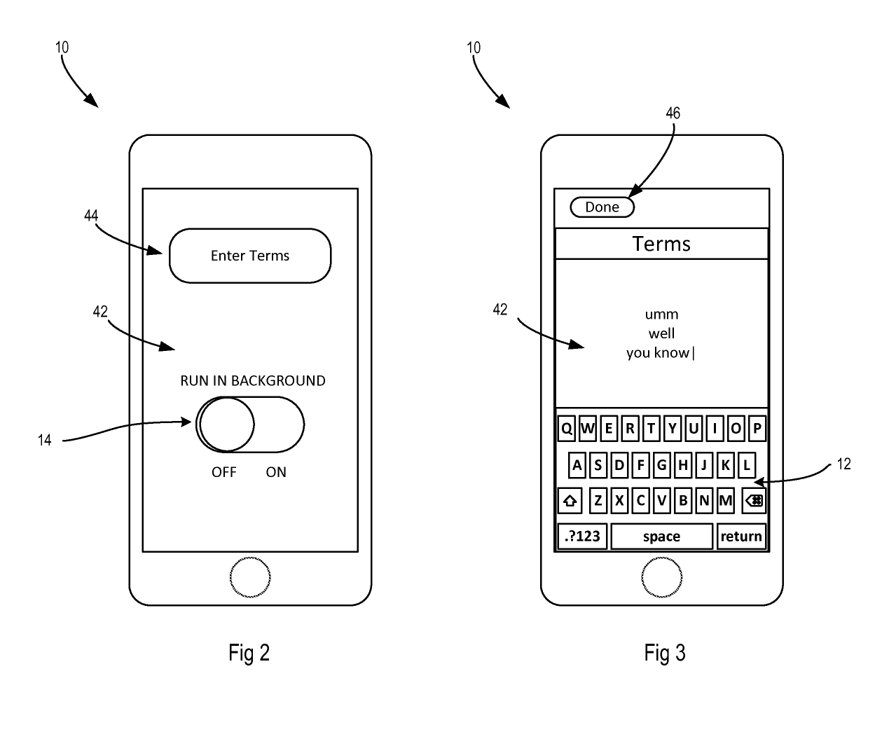

FIG. 2 illustrates an interface 42 that is displayed on a display of the mobile phone 10. The interface 42 includes the interface switch 14 that can be switched between an “off” state and an “on” state. The interface 42 further has a button 44 that is selectable by the user for purposes of entering terms.

FIG. 3 show the interface 42 after the user has selected the button 44 in FIG. 2. The user uses the keyboard 12 in FIG. 1 to enter terms that the user wishes to serve as feedback events. A term may include a single word or two or more words. After the user has entered the terms, the user selects a button 46 to store the terms as the terms 40 in the data store 22 shown in FIG. 1. The user can delete terms as well as add them. The system analyzes words/phrases that are entered by a user and corrects if needed, e.g., correct spelling or determine whether a word is a valid English word and then correct is, etc.).

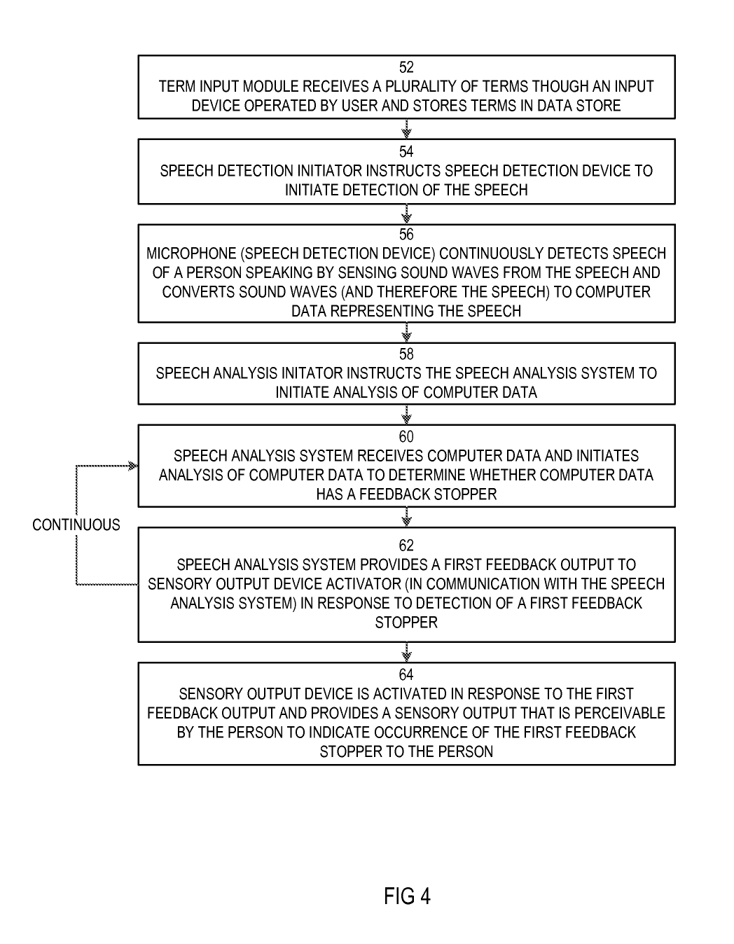

FIG. 4 illustrates a method of operating the mobile phone 10 in FIG. 1. At 52, the term input module 34 receives a plurality of terms though an input device (the keyboard 12) operated by user and stores the terms in the data store 22 as the terms 40. In another embodiment, a term input module may for example be a microphone that receives voice terms from the user and converts the voice terms to text terms. Alternatively, the terms may be voice data that is stored in the data store 22. If the user enters words via audio, the matching algorithm has two options: 1) convert the audio into text and match to text reference terms that are in text form, or 2) match the audio from the user to audio reference terms.

At 54, the speech detection initiator 36 instructs the speech detection device (the microphone 16) to initiate detection of the speech. As mentioned previously, the microphone 16 senses waves due to speech. In another embodiment, a speech detection device may be a device other than a microphone, for example a camera that can visually detect utterances made by a person.

At 56, the microphone 16 continuously detects speech of a person speaking by sensing sound waves from the speech and converting the sound waves (and therefore the speech) to the computer data 28 that represents the speech. Although there may be pauses in the speech of the person speaking, the microphone 16 does not stop its sensing of the sound waves and continues to convert whatever sound waves it detects to the computer data 28.

At 58, the speech analysis initiator 38 instructs the comparator 32 of the speech analysis system 24 to initiate analysis of the computer data 28 received by the data receiver 30.

At 60, the comparator 32 of the speech analysis system 24 receives the computer data 28 and initiates analysis of the computer data 28 to determine whether the computer data 28 has a feedback event.

At 62, the comparator 32 of the speech analysis system 24 provides a first feedback output to the sensory output device activator in response to detection of a first feedback event.

At 64, the sensory output device 18 is activated in response to the first feedback output and provides a sensory output that is perceivable by the person to indicate occurrence of the first feedback event to the person.

Steps 60 and 62 are continuously carried out so that a second and further feedback output can be provided to the person at step 64.

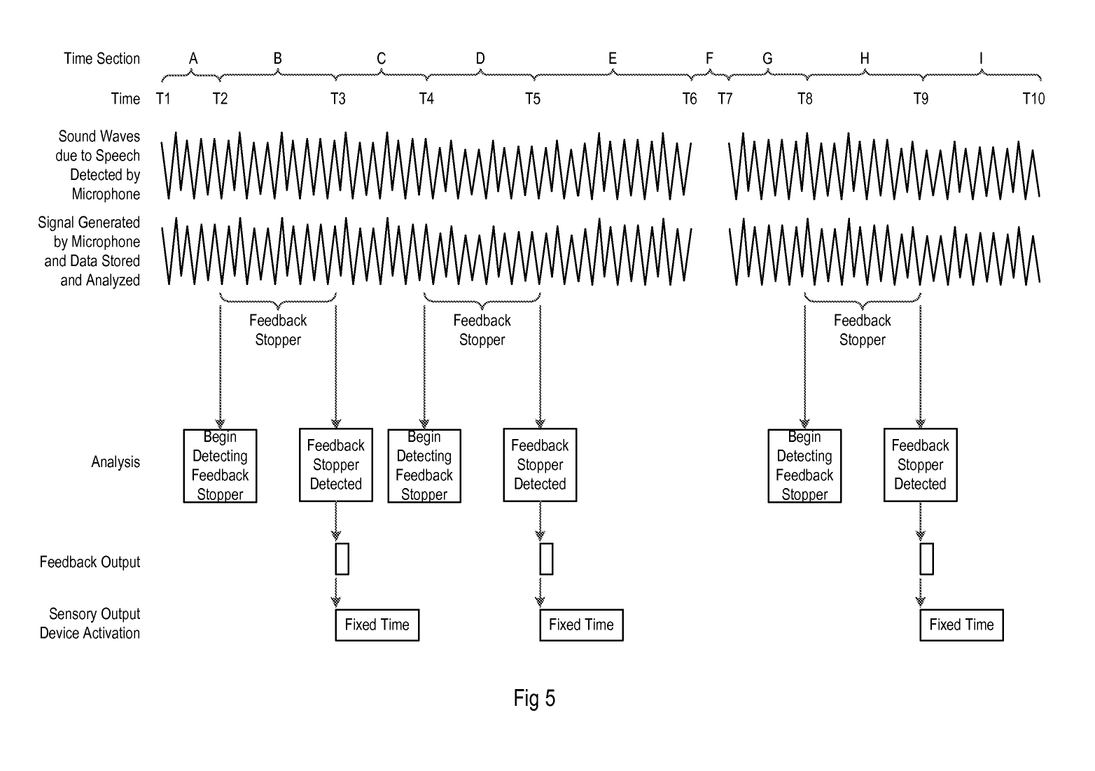

FIG. 5 illustrates the continuous nature of monitoring speech of the user and providing feedback to the user. Sound waves, due to speech, are continuously detected by the microphone 16 during consecutive time sections A to I. The user may pause their speech during a time section, for example time section F. The microphone 16 remains on while the person pauses their speech and continues to detect whatever sound waves exist due to speech of the user.

A signal is continuously generated by the microphone 16 and data is continuously stored and analyzed during all time sections A to I except when no speech is detected by the microphone 16 during time section F. The computer data 28 is thus analyzed practically in real time while the microphone 16 senses the sound waves due to the speech. The analysis starts at T1 and detects no feedback event during time section A. The speech includes a feedback event in time section B that starts at T2 and ends at T3. The analysis system 24 begins to detect the feedback event at T2 and the feedback event is finally detected at T3. When the analysis system 24 detects the feedback event at T3, the analysis system 24 provides a feedback output. The feedback output results in a sensory output device activation starting at T3. The sensory output device activation typically lasts for a fixed amount of time, for example 2 seconds.

During time section C starting at T3 and ending at T4, no feedback event is detected by the analysis system 24. The microphone 16 continues to detect the sound waves due to the speech and the analysis system 24 continues to analyze the computer data 28 to determine whether a feedback event is detected. At T4, the analysis system 24 begins to detect a second feedback event. The feedback event exists in the computer data 28 in time section D starting at T4 and ending at T5. At T5, the analysis system 24 completes the detection of the feedback event and provides a feedback output. The feedback output causes a sensory output device activation for a fixed amount of time, for example 2 seconds.

During time section E, starting at T5 and ending at T6, the microphone 16 continues to detect speech of the user and the analysis system 24 continues to analyze the computer data 28 to determine whether there is a feedback event. In the present example, no feedback event is detected during time section E.

During time section F, the user pauses their speech. The microphone 16 is still on, but does not provide any data to the analysis system for analysis. Alternatively, the analysis system 24 may be tuned to filter out any background noise detected by the microphone 16.

At T7, the user resumes their speech and the microphone 16 continues to create computer data 28 that is analyzed by the analysis system 24. During time section G, starting at T7 and ending at T8, no feedback event exists within the speech of the user and the analysis system 24 does not detect a feedback event.

A feedback event exists in the speech in time section H from T8 to T9. At T8, the analysis system 24 begins to detect the feedback event and the feedback event is finally detected at T9. At T9, the analysis system 24 again provides a feedback output and the sensory output device 18 is activated to cause a sensory output to the user for a fixed amount of time. During time section I, starting at T9 and ending at T10, no feedback event is detected by the analysis system 24.

A sensory output is provided to the user for any feedback events in their speech while they are speaking The sensory output provides immediate feedback to the user when the feedback event is detected. The user can continue to speak while the sensory output is provided to them without terminating analysis of their speech. Further sensory outputs will thus be provided to the user if further feedback events exist within their speech.

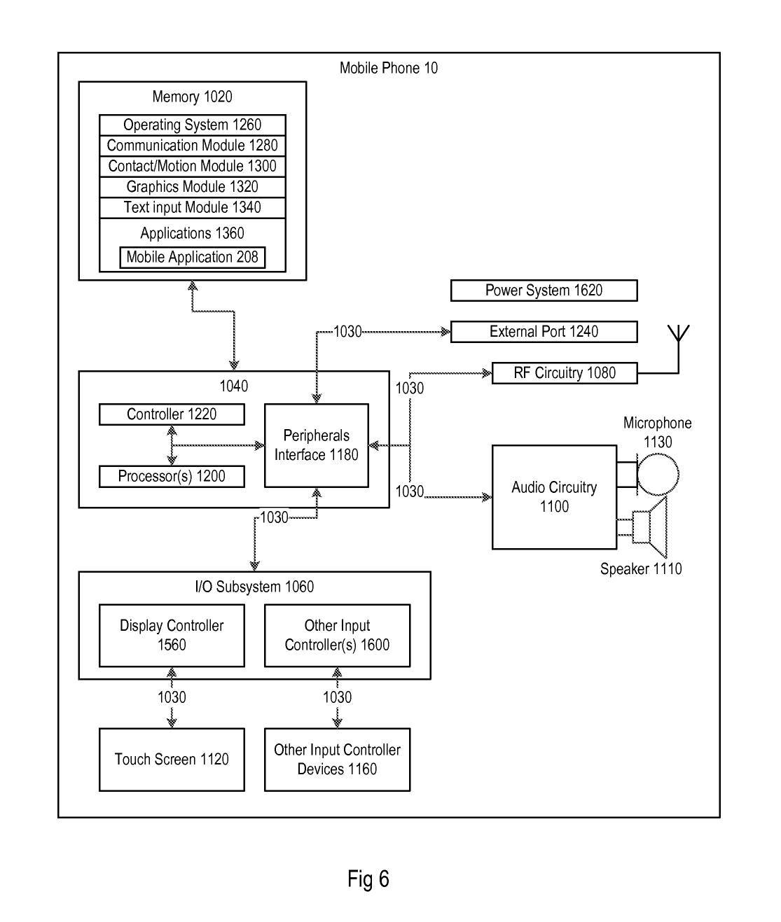

FIG. 6 is a block diagram illustrating the mobile phone 10, illustrating a touch-sensitive display 1120 or a “touch screen” for convenience. The mobile phone 10 includes a memory 1020 (which may include one or more computer readable storage mediums), a memory controller 1220, one or more processing units (CPU's) 1200, a peripherals interface 1180, RF circuitry 1080, audio circuitry 1100, a speaker 1110, a microphone 1130, an input/output (I/O) subsystem 1060, other input or control devices 1160 and an external port 1240. These components communicate over one or more communication buses or signal lines 1030.

The various components shown in FIG. 6 may be implemented in hardware, software or a combination of hardware and software, including one or more signal processing and/or application specific integrated circuits.

The memory 1020 may include high-speed random access memory and may also include non-volatile memory, such as one or more magnetic disk storage devices, flash memory devices, or other non-volatile solid-state memory devices. Access to the memory 1020 by other components of the mobile phone 10, such as the CPU 1200 and the peripherals interface 1180, is controlled by the memory controller 1220.

The peripherals interface 1180 connects the input and output peripherals of the device to the CPU 1200 and memory 1020. The one or more processors 1200 run or execute various software programs and/or sets of instructions stored in the memory 1020 to perform various functions for the mobile phone 10 and to process data.

The RF (radio frequency) circuitry 1080 receives and sends RF signals, also called electromagnetic signals. The RF circuitry 1080 converts electrical signals to/from electromagnetic signals and communicates with communications networks and other communications devices via the electromagnetic signals. The RF circuitry 1080 includes well-known circuitry for performing these functions, including an antenna system, an RF transceiver, one or more amplifiers, a tuner, one or more oscillators, a digital signal processor, a CODEC chipset, a subscriber identity module (SIM) card, memory, and so forth. The RF circuitry 1080 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies that are known in the art.

The audio circuitry 1100, the speaker 1110, and the microphone 1130 provide an audio interface between a user and the mobile phone 10. The audio circuitry 1100 receives audio data from the peripherals interface 1180, converts the audio data to an electrical signal, and transmits the electrical signal to the speaker 1110. The speaker 1110 converts the electrical signal to human-audible sound waves. The audio circuitry 1100 also receives electrical signals converted by the microphone 1130 from sound waves. The audio circuitry 1100 converts the electrical signal to audio data and transmits the audio data to the peripherals interface 1180 for processing. The audio circuitry 1100 also includes a headset jack serving as an interface between the audio circuitry 1100 and removable audio input/output peripherals, such as output-only headphones or a headset with both output (e.g., a headphone for one or both ears) and input (e.g., a microphone).

The I/O subsystem 1060 connects input/output peripherals on the mobile phone 10, such as the touch screen 1120 and other input/control devices 1160, to the peripherals interface 1180. The I/O subsystem 1060 includes a display controller 1560 and one or more input controllers 1600 for other input or control devices. The one or more input controllers 1600 receive/send electrical signals from/to other input or control devices 1160. The other input/control devices 1160 may include physical buttons (e.g., push buttons, rocker buttons, etc.), dials, slider switches, joysticks, click wheels, and so forth all serving as forming part of an interface. The input controllers 1600 may be connected to any of the following: a keyboard, infrared port, USB port, and a pointer device such as a mouse. The one or more buttons may include an up/down button for volume control of the speaker 1110 and/or the microphone 1130. The one or more buttons may include a push button. A quick press of the push button may disengage a lock of the touch screen 1120 or begin a process that uses gestures on the touch screen to unlock the device. A longer press of the push button may turn power to the mobile phone 10 on or off. The touch screen 1120 is used to implement virtual or soft buttons and one or more soft keyboards.

The touch screen 1120 provides an input interface and an output interface between the device and a user. The display controller 1560 receives and/or sends electrical signals from/to the touch screen 1120. The touch screen 1120 displays visual output to the user. The visual output may include graphics, text, icons, video, and any combination thereof (collectively termed “graphics”). In some embodiments, some or all of the visual output may correspond to user-interface objects, further details of which are described below.

A touch screen 1120 has a touch-sensitive surface, sensor or set of sensors that accepts input from the user based on haptic and/or tactile contact. The touch screen 1120 and the display controller 1560 (along with any associated modules and/or sets of instructions in memory 1020) detect contact (and any movement or breaking of the contact) on the touch screen 1120 and converts the detected contact into interaction with user-interface objects (e.g., one or more soft keys, icons, web pages or images) that are displayed on the touch screen. In an exemplary embodiment, a point of contact between a touch screen 1120 and the user corresponds to a finger of the user.

The touch screen 1120 may use LCD (liquid crystal display) technology, or LPD (light emitting polymer display) technology, although other display technologies may be used in other embodiments. The touch screen 1120 and the display controller 1560 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 1120.

The user may make contact with the touch screen 1120 using any suitable object or appendage, such as a stylus, a finger, and so forth. In some embodiments, the user interface is designed to work primarily with finger-based contacts and gestures, which are much less precise than stylus-based input due to the larger area of contact of a finger on the touch screen. In some embodiments, the device translates the rough finger-based input into a precise pointer/cursor position or command for performing the actions desired by the user.

The

mobile phone 10 also includes a power system 1620 for powering the various components. The power system 1620 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The software components stored in memory 1020 include an operating system 1260, a communication module (or set of instructions) 1280, a contact/motion module (or set of instructions) 1300, a graphics module (or set of instructions) 1320, a text input module (or set of instructions) 1340, and applications (or set of instructions) 1360.

The operating system 1260 (e.g., iOS, Android or Windows) includes various software components and/or drivers for controlling and managing general system tasks (e.g., memory management, storage device control, power management, etc.) and facilitates communication between various hardware and software components.

The communication module 1280 facilitates communication with other devices over one or more external ports 1240 and also includes various software components for handling data received by the RF circuitry 1080 and/or the external port 1240. The external port 1240 (e.g., Universal Serial Bus (USB), LIGHTNING, etc.) is adapted for coupling directly to other devices or indirectly over a network (e.g., the Internet, wireless LAN, etc.).

The contact/motion module 1300 may detect contact with the touch screen 1120 (in conjunction with the display controller 1560) and other touch sensitive devices (e.g., a touchpad or physical click wheel). The contact/motion module 1300 includes various software components for performing various operations related to detection of contact, such as determining if contact has occurred, determining if there is movement of the contact and tracking the movement across the touch screen 1120, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). The contact/motion module 1300 and the display controller 1560 also detects contact on a touchpad.

The graphics module 1320 includes various known software components for rendering and displaying graphics on the touch screen 1120, including components for changing the intensity of graphics that are displayed. As used herein, the term “graphics” includes any object that can be displayed to a user, including text, web pages, icons (such as user-interface objects including soft keys), digital images, videos, animations and the like.

The text input module 1340, which may be a component of graphics module 1320, provides soft keyboards for entering text in various applications (e.g., contacts, e-mail, IM, blogging, browser, and any other application that needs text input). The applications 1360 may include a mobile application 208 that includes the speech analysis system 24, interface switch 14 and instructional module 26 in FIG. 1.

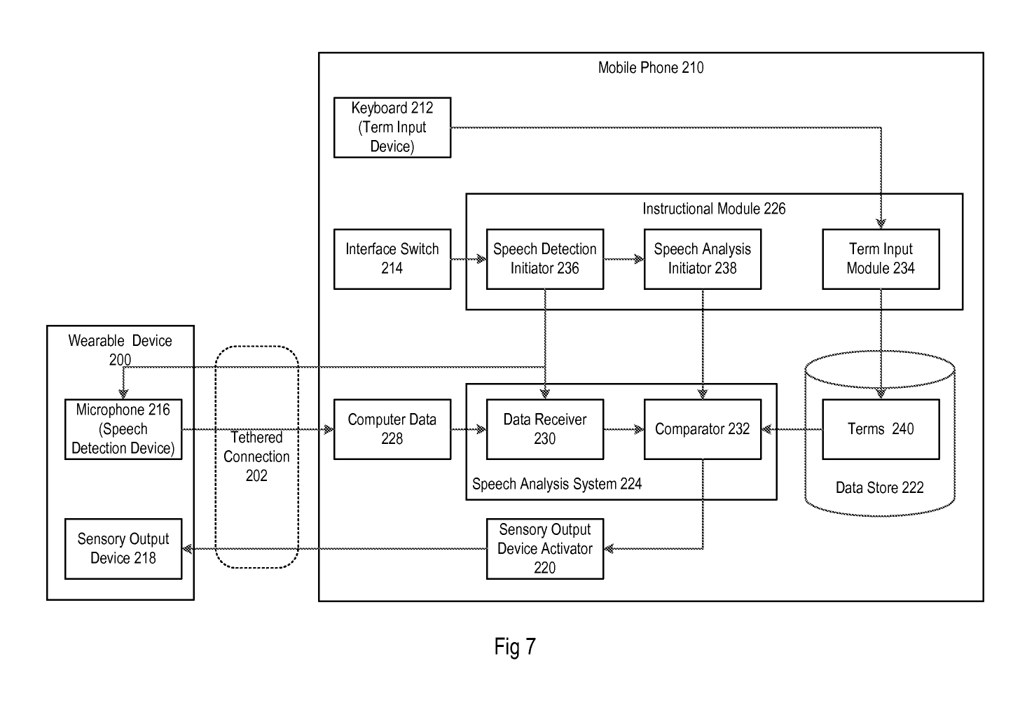

FIG. 7 shows a speech feedback system that includes a wearable device 200 that is connected to a mobile phone 210 using a tethered connection 202 that may be provided using the RF circuitry 1080 in FIG. 6. The wearable device 200 may for example be a computer-based watch that can be worn on a person's wrist. The wearable device 200 includes a microphone 216 and a sensory output device 218. The mobile phone 210 includes a keyboard 212, an interface switch 214, a sensory output device activator 220, a data store 222, a speech analysis system 224 and an instructional module 226. The instructional module 226 has a term input module 234, a speech detection initiator 236 and a speech analysis initiator 238.

Terms 240 are stored in the data store 222 by the keyboard 212 and the term input module 234. The speech detection initiator 236 activates the microphone 216 over the tethered connection 202. The microphone 216 senses sound waves due to speech of a person wearing the wearable device 200 and generates computer data representing the speech. The wearable device 200 transmits the computer data over the tethered connection 202 and the mobile phone 210 receives the computer data as computer data 228. The sensory output device activator 220 activates the sensory output device 218 over the tethered connection 202. The functioning of the components of the speech feedback system for FIG. 7 is the same as the functioning of the components of the speech feedback system of FIG. 1 in all other respects. One advantage of the use of a wearable device such as a computer-based watch is that it is always worn in the same position on the wrist of the user and can be tuned for receiving sound waves representing accurate speech data at such a position.

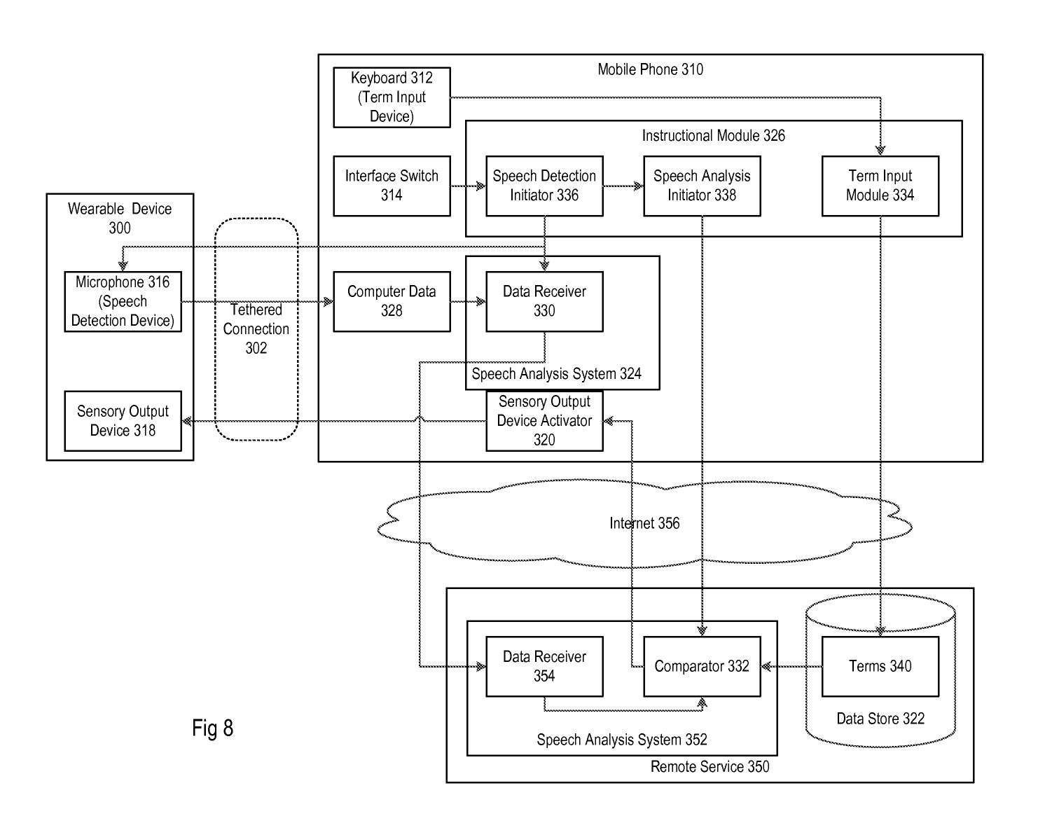

FIG. 8 illustrates a speech feedback system according to a further embodiment of the invention. As with the embodiment in FIG. 7, the speech feedback system of FIG. 8 includes a mobile phone 310 and a wearable device 300 that is connected to the mobile phone 310 over a tethered connection 302. The mobile phone 310 includes a keyboard 312, an interface switch 314, a speech analysis system 324, an instructional module 326 and a sensory output device activator 320. The instructional module 326 includes a term input module 334, a speech detection initiator 336 and a speech analysis initiator 338 that function in a manner similar to the embodiment of FIG. 7. The speech analysis system 324 includes a data receiver 330 that receives computer data 328 over the tethered connection 302 from a microphone 316 forming part of the wearable device 300.

In addition, the speech feedback system of FIG. 8 includes a remote service 350 that has a data store 322 and a speech analysis system 352. The speech analysis system 352 includes a data receiver 354 and a comparator 332. The remote service 350 is connected over the Internet 356 to the mobile phone 310.

In use, the user uses the keyboard 312 to enter terms that are received by the term input module 334. The term input module 334 sends the terms over the Internet 356 to the remote service 350 which stores the terms as terms 340 in the data store 322.

When the interface switch 314 is activated, the speech detection initiator 336 initiates reception of the computer data 328 by the data receiver 330 forming part of the speech analysis system 324 of the mobile phone 310. The data receiver 330 then sends the computer data 328 to the data receiver 354 forming part of the speech analysis system 352 of the remote service 350. The comparator 332 of the speech analysis system 352 analyzes the computer data 328 received by the data receiver 354 to determine whether the computer data 328 has any one of the terms 340 that serve as feedback events. When the comparator 332 detects a feedback event, the comparator 332 sends an instruction over the Internet 356 to the sensory output device activator 320 of the mobile phone 310. The sensory output device activator 320 then activates a sensory output device 318 of the wearable device 300 over the tethered connection 302.

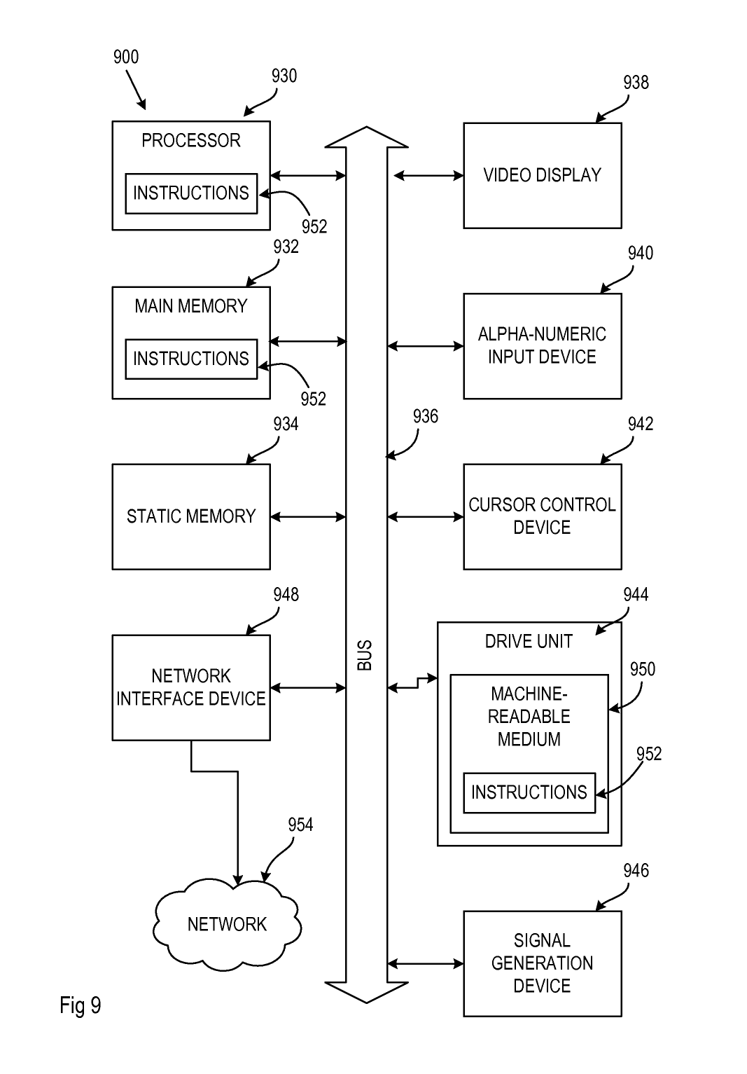

FIG. 9 shows a diagrammatic representation of the remote service 350 of FIG. 8 in the exemplary form of a computer system 900 within which a set of instructions, for causing the machine to perform any one or more of the methodologies discussed herein, may be executed. In alternative embodiments, the machine operates as a standalone device or may be connected (e.g., networked) to other machines. In a network deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a wearable, a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processor 930 (e.g., a central processing unit (CPU), a graphics processing unit (GPU), or both), a main memory 932 (e.g., read-only memory (ROM), flash memory, dynamic random access memory (DRAM) such as synchronous DRAM (SDRAM) or Rambus DRAM (RDRAM), etc.), and a static memory 934 (e.g., flash memory, static random access memory (SRAM, etc.), which communicate with each other via a bus 936.

The computer system 900 may further include a video display 938 (e.g., a liquid crystal displays (LCD) or a cathode ray tube (CRT)). The computer system 900 also includes an alpha-numeric input device 940 (e.g., a keyboard), a cursor control device 942 (e.g., a mouse), a disk drive unit 944, a signal generation device 946 (e.g., a speaker), and a network interface device 948.

The disk drive unit 944 includes a machine-readable medium 950 on which is stored one or more sets of instructions 952 (e.g., software) embodying any one or more of the methodologies or functions described herein. The software may also reside, completely or at least partially, within the main memory 932 and/or within the processor 930 during execution thereof by the computer system 900, the memory 932 and the processor 930 also constituting machine readable media. The software may further be transmitted or received over a network 954 via the network interface device 948.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A speech feedback system comprising:
a speech detection device for continuously detecting speech of a person speaking and converting the speech to computer data representing the speech;
a speech analysis system configured to receive the computer data and initiate analysis of the computer data to determine whether the computer data has a feedback event, wherein no feedback event is detected for a first time section of the computer data and a first feedback event is detected in a second time section after the first time section;
a sensory output device activator connected to the speech analysis system so that, when the speech analysis system detects the first feedback event, the speech analysis system provides a first feedback output to the sensory output device activator in response to the detection of the first feedback output; and
a sensory output device connected to the sensory output device activator so as to be activated in response to the first feedback output, the sensory output device providing a sensory output that is perceivable by the person to indicate occurrence of the first feedback event to the person, while continuously detecting the speech and continuously analyzing the speech.

2. The speech feedback system of claim 1, wherein the speech detection device is a microphone that detects the speech by sensing sound waves from the speech and converts the sound waves to the computer data.

3. The speech feedback system of claim 1, wherein the analysis is continuously carried out while the speech is continuously being detected.

4. The speech feedback system of claim 1, wherein a first feedback output is provided while continuously detecting the speech.

5. The speech feedback system of claim 4, wherein the sensory output device is activated while continuously detecting the speech and continuously analyzing the speech.

6. The speech feedback system of claim 1, wherein no feedback event is detected for a third time section after the second time section and a second feedback event is detected in a fourth time section after the third time section, when the second feedback event is detected, providing a second feedback output in response to the detection of the second feedback output, and the sensory output device is activated in response to the second feedback output, the sensory output device providing a sensory output that is perceivable by the person to indicate occurrence of the second feedback event to the person, while continuously detecting the speech and continuously analyzing the speech.

7. The speech feedback system of claim 6, wherein the analysis is continuously carried out while the speech is continuously being detected in the third section of time.

8. The speech feedback system of claim 1, wherein the feedback event is a term that includes one or more words spoken over a period of time and the term is detected at the end of the period of time.

9. The speech feedback system of claim 8, further comprising:
a data store; and
a term input module receiving a plurality of terms though an input device operated by the user and storing the terms in a data store.

10. The speech feedback system of claim 9, further comprising:
a speech detection initiator that instructs the speech detection device to initiate detection of the speech; and
a speech analysis initiator that instructs the speech analysis system to initiate analysis of the computer data.

11. The speech feedback system of claim 10, further comprising:
an instructional module separate from the speech analysis system, the term input module, speech detection initiator and speech analysis initiator forming part of the instructional module.

12. The speech feedback system of claim 1, further comprising:
a data receiver receiving the computer data and transmitting the computer data from a mobile device over a network to a remote service, wherein the sensory feedback device activator receives a result at the mobile device from the remote service indicating that the first feedback event is detected by the remote service and the sensory feedback device activator receives a result at the mobile device from the remote service indicating that the second feedback event is detected by the remote service.

13. The speech feedback system of claim 12, further comprising:
a term input module receiving a plurality of terms though an input device operated by the user, and
transmitting the terms to the remote service, wherein the feedback event is a term that includes one or more words spoken over a period of time and the term is detected at the end of the period of time by the remote service.

14. A method of providing speech feedback to a person speaking comprising:
continuously detecting speech of a person speaking with a speech detection device and converting the speech to computer data representing the speech;
initiating analysis of the computer data to determine whether the computer data has a feedback event, wherein no feedback event is detected for a first time section of the computer data and a first feedback event is detected in a second time section after the first time section;
when the first feedback event is detected, providing a first feedback output in response to the detection of the first feedback output; and
activating a sensory output device in response to the first feedback output, the sensory output device providing a sensory output that is perceivable by the person to indicate occurrence of the first feedback event to the person, while continuously detecting the speech and continuously analyzing the speech.

15. The method of claim 14, wherein the speech detection device is a microphone that detects the speech by sensing sound waves from the speech and converts the sound waves to the computer data.

16. The method of claim 14, wherein the analysis is continuously carried out while the speech is continuously being detected.

17. The method of claim 14, wherein a first feedback output is provided while continuously detecting the speech.

18. The method of claim 17, wherein the sensory output device is activated while continuously detecting the speech and continuously analyzing the speech.

19. The method of claim 14, wherein no feedback event is detected for a third time section after the second time section and a second feedback event is detected in a fourth time section after the third time section, further comprising:
when the second feedback event is detected, providing a second feedback output in response to the detection of the second feedback output; and
activating the sensory output device in response to the second feedback output, the sensory output device providing a sensory output that is perceivable by the person to indicate occurrence of the second feedback event to the person, while continuously detecting the speech and continuously analyzing the speech.

20. The method of claim 19, wherein the analysis is continuously carried out while the speech is continuously being detected in the third section of time.

21. The method of claim 14, wherein the feedback event is a term that includes one or more words spoken over a period of time and the term is detected at the end of the period of time.

22. The method of claim 21, further comprising:
receiving a plurality of terms though an input device operated by the user; and
storing the terms in a data store.

23. The method of claim 14, further comprising:
transmitting the computer data from a mobile device over a network to a remote service;
receiving a result at the mobile device from the remote service indicating that the first feedback event is detected by the remote service; and
receiving a result at the mobile device from the remote service indicating that the second feedback event is detected by the remote service.

24. The method of claim 23, further comprising:
receiving a plurality of terms though an input device operated by the user; and
transmitting the terms to the remote service, wherein the feedback event is a term that includes one or more words spoken over a period of time and the term is detected at the end of the period of time by the remote service.

25. A computer-readable medium having stored thereon a set of instructions which, when executed by a processor carries out a method of providing speech feedback to a person speaking comprising:
continuously detecting speech of a person speaking with a speech detection device and converting the speech to computer data representing the speech;
initiating analysis of the computer data to determine whether the computer data has a feedback event, wherein no feedback event is detected for a first time section of the computer data and a first feedback event is detected in a second time section after the first time section;
when the first feedback event is detected, providing a first feedback output in response to the detection of the first feedback output; and
activating a sensory output device in response to the first feedback output, the sensory output device providing a sensory output that is perceivable by the person to indicate occurrence of the first feedback event to the person, while continuously detecting the speech and continuously analyzing the speech.
